(19) United States
(12) Patent Application Publication
(10) Pub. No.: US 2020/0210946 A1
(43) Pub. Date: Jul. 2, 2020

(54) Manufacturing Procurement Process Enabling Part Certification, Verification, Tracking, Storage, Part Tokenization, and Facilitating Audit, Traceability, Recall and Anti-Fraud Measures Using Blockchain Technology.

(71) Applicant: Jeremiah Goodwin, (US)

(72) Inventor: Jeremiah Goodwin, San Leandro, CA (US)

(73) Assignee: SyncFab Co., San Leandro, CA (US)

(21) Appl. No.: 16/731,840

(22) Filed: Dec. 31, 2019

Related U.S. Application Data
(60) Provisional application No. 62/917,788, filed on Dec. 31, 2018.

(51) Int. Cl. G06Q 10/08; H04L 9/06

(52) U.S. Cl. CPC G06Q 10/087; H04L 2209/38; H04L 9/0637

(57) ABSTRACT

The manufacturing procurement process described herein allows for the entire manufacturing production process and components to be encoded onto a live distributed manufacturing network platform that combines distributed ledger technology to permit verification, tracking and storage on a specialized blockchain tailored to the protocol and standards of industrial manufacturing. This process also assigns a unique digital blockchain-based “token” that corresponds with each specific Purchase Order, Part, and End Product, and encompasses the specific details relating to that Purchase Order, Part, or End Product, including the original order specifications and production requirements. The use of cryptographically-secured blockchain technology in this process improves the efficiency and traceability of the supply chain, enhancing the audit, traceability, recall and anti-fraud capabilities of manufacturers, and saving significant costs to suppliers, buyers, and ultimately, end users.

### BACKGROUND OF THE INVENTION

### Field of the Invention

The present invention relates generally to a method for the fulfillment of Purchase Orders and subsequent tracing of parts in the manufacturing and supply-chain process using blockchain technology.

### Related Art

The manufacturing supply chain is rife with inefficiencies and uncertainties, including a lack of clarity about the timing of production and deliveries, quality of materials, sourcing of materials, and supplier inventory. Moreover, a lack of trust between buyers and suppliers often exposes the parties to legal risk and financial loss.

Other supply chain processes involving the fulfillment of purchase orders tend to force the parties to take on a burdensome level of risk in each transaction, as it can be unclear where, when, and to what extent something has gone wrong somewhere in the supply chain. It can be extremely costly to a business, for instance, if, by some miscommunication or other error, specifications for a particular part were not met, resulting in either an inability or significant delays in completing production of a separate end product. It could also take months or years to pinpoint the source of the problem, which can potentially place some unknown and unidentifiable number of end users at risk. As parts and products are often difficult to track within supply chains common issues that can arise include fraud, spoiled goods, and product recalls, causing millions of dollars in damage.

The existing processes are also more prone to failures, uncertainties, inefficiencies, and human error than the method disclosed here—and have otherwise failed to make full use of blockchain technology to eliminate supply chain inefficiencies. They also require a certain level of “trust” between buyers and suppliers, which can have the effect of preventing the entry of smaller suppliers into the supply chain, as they are unable to have gained the necessary “trust”. Moreover, slow manual processes (e.g., phone calls and miscellaneous paperwork) are required to manage suppliers and ascertain trust.

This invention involves the utilization of the “digital trust” and tamper-proof features of blockchain technology within the supply chain, which minimizes the risks and costs involved in manufacturing, and eliminates the possibility of duplicative, discordant, or otherwise inefficient elements of the supply chain.

This invention minimizes the uncertainties inherent in the manufacturing supply chain by allowing buyers and suppliers to cryptographically encode, track, and verify standards for specific parts unique to a purchase order, thereby ensuring that purchase order specifications—and, in turn, expectations—are met. In addition, the invention enhances the efficiency and traceability of the supply chain, allowing manufacturers to more easily audit, trace, recall and implement anti-fraud measures with respect to parts made.

### BRIEF SUMMARY OF THE INVENTION

This invention relies on cryptographically-secured blockchain technology to eliminate the inefficiencies that frequently permeate the supply chain.

The manufacturing procurement process described herein allows for the entire manufacturing production process (e.g., from RFQ, to Purchase Order, to smart contract fulfillment, to final order certification) to be encoded onto a hybrid software/blockchain system (i.e., a live distributed manufacturing network platform combined with distributed ledger technology) that permits verification, tracking and storage on a specialized blockchain tailored to the protocol and standards of industrial manufacturing.

This process also assigns a unique digital blockchain-based “token” that corresponds with each specific Purchase Order, Part, and End Product, and encompasses the specific details relating to that Purchase Order, Part, or End Product, including the original order specifications and production requirements. The use of cryptographically-secured blockchain technology in this process improves the efficiency of the supply chain, saving significant costs to suppliers, buyers, and ultimately, end users.

This invention involves three main components, listed below:
1) Individual Purchase Order Tokenization;
2) Individual Part Tokenization; and
3) End-Product Tokenization.

The Relationship Between the three Components is described as follows:
1) Individual Purchase Order Tokenization

A Purchase Order's requirements, specifications and other key information are encoded and linked to a blockchain-based token.
2) Individual Part Tokenization

Individual parts or components, originating from the Purchase Order, are then created, and are themselves linked to unique tokens containing the specifications, requirements, and other key information required for the part.
3) End-Product Tokenization

Finally, the End Product, once assembled, is itself linked to a unique token, and is comprised of individual parts that are each tokenized, and therefore traceable and identifiable.

### BRIEF DESCRIPTION OF THE DRAWINGS

FIG. 1. The part tokenization diagram reflects the assignment of a unique token (represented here with a depiction of an “MFG” token and a set of characters indicating a token address) to each part or component of a larger end product. The token, in turn, contains the specifications that originated from the Purchase Order as applicable.

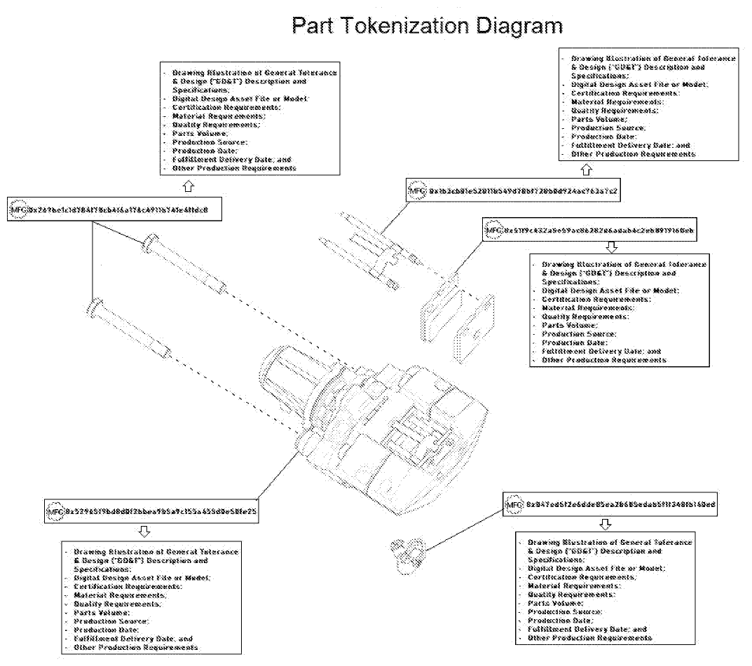

### DETAILED DESCRIPTION OF THE INVENTION

1. Individual Purchase Order Tokenization: The process involved in the instant invention begins when a buyer submits a Purchase Order containing certain specifications. The Purchase Order's overall requirements and specifications are encoded into a unique token. The token's encoding would then reflect the component part's specifications such as the following:
Certification Requirements;
Quality Requirements;
Parts Volume;
Production Source;
Production Date;
Fulfillment Delivery Date; and
Other Production Requirements

The end result is that the Purchase Order creates a unique record on the blockchain (containing the Purchase Order's key underlying information) represented by a unique block number, which is in turn represented by a unique digital token. Using the live distributed manufacturing network platform and subsequent validation and storage using distributed ledger (blockchain) technology, a digital file is created and stored. The Purchase Order can then be tracked via tamper-proof blockchain technology, and the token itself can function as a unique security key to access the block record file itself.

2. Individual Part Tokenization: The information related to specific component parts in a supply chain intended for assembly of an end product is also tokenized. From the Purchase Order, a unique individual component or part is originated. The component or part is linked exclusively to a specific token and contains the purchase order requirements and specifications, as listed above in Individual Purchase Order Tokenization, and is stored digitally as with the Purchase Order. Information tied to specific parts in the tokenization process include:
“SyncFabPartID”
“PartNumber”
“SyncFabCompanyID”
“parentrevision”,
“PurchaseOrderID”
“finishSupplierID”:
“manufacturerSupplierID”
“materialSupplierID”
“quantity”
“requiredCertifications”
“supportedFile”
“trackableID”

The end result is that a specific part or component is linked to a unique record on the blockchain (reflecting the specifications called for in the Purchase Order) represented by a unique block number, which is in turn represented by a unique digital token.

The physical part can then be tracked, facilitated by a corresponding physical tracker, which includes a unique part number, engraving, number sticker, bar code, RFID tags or smart label, or other identifier linked to the block record and unique token information.

3. End-Product Tokenization: At the End Product stage, each end product is ultimately comprised of individual parts or components that have been “tokenized” as described above, and each originating from the Purchase Order that initiated the process. The end result is that, at any point, the buyer or end user could potentially track each component part to its original source, along the Purchase Order that originated the part, and the material and other specifications that the part consists of, as listed above. In this way, even if a buyer or end user loses the certificates or documents that accompany a Purchase Order or a part, they can always retrieve the relevant information or documentation from the specialized blockchain.

As with the Individual Part Tokenization, the End Product contains a Physical corresponding tracker on component part which includes a unique part number, engraving, number sticker, bar code, RFID tags or smart labels, or other identifier linked to the block record and unique token information.

The End Product itself is tokenized in a process similar to Individual Purchase Order Tokenization and Individual Part Tokenization. In this case, the token that corresponds to the End Product would include additional information (such as, for instance the culmination of all component parts), as well as certifications specific to the End Product as required by the product commercial brand and their customers. For example, the End Product's corresponding token could be encoded to include a unique security key for product upgrade purposes, or recall information, technical documentation, maintenance documentation, product certifications, and software upgrade information.

Successful Implementation: By following the above-listed process, in the order listed, a buyer's requirements and specifications are met and each individual part within an End Product, as well as the End Product itself, are encoded and linked to a blockchain-based token, rendering the entire product's components through the whole production process identifiable and traceable. I.e., each individual part within an End Product, as well as the End Product itself, are therefore identifiable and traceable.

The tokenization of the Purchase Order and Individual Part must be performed in its entirety for the means disclosed here to succeed. Because both the Purchase Order and the Individual Parts comprising the End Product are tokenized, the End Product itself may or may not be tokenized, depending on the product's commercial brand, their customers, and other factors.

The tokenized Individual Parts could potentially be re-purposed for different Purchase Orders or End Products, or for other purposes that differ from their original intended use.

In the manner described above, the instant process may be used in the creation of a potentially unlimited number of End Products.

What is claimed is:

1. A manufacturing procurement process that enables the entire production process to be encoded onto a hybrid software/blockchain system that combines a live distributed manufacturing network platform with distributed ledger technology as shown and described herein.

2. The tokenization of Purchase Orders, Parts, and End Products with blockchain technology as shown and described herein.

3. The facilitation of Audit, Traceability, Recall and Anti-Fraud protections within the manufacturing supply chain process with the use of blockchain technology.
